(19) United States
(12) Patent Application Publication
(10) Pub. No.: US 2017/0011368 A1
(43) Pub. Date: Jan. 12, 2017

(54) SECURE CREDIT CARD IDENTIFICATION SYSTEM

(71) Applicant: MARC TROMBINO, Staten Island, NY (US)

(72) Inventor: MARC TROMBINO, Staten Island, NY (US)

(21) Appl. No.: 14/793,055

(22) Filed: Jul. 7, 2015

(51) Int. Cl. G06Q 20/10; G06Q 20/40; G06Q 20/20; G06K 9/00

(52) U.S. Cl. CPC G06Q 20/102; G06K 9/00288; G06K 9/00255; G06K 9/00926; G06Q 20/40145; G06Q 20/20

(57) ABSTRACT

A system and method for capturing an image during a financial transaction is provided for. The method can verify the identity of an individual by utilizing a memory that stores computer-executable instructions and a processor which is communicatively coupled to the memory that facilitates execution of these computer-executable instructions. The instructions help perform the method of initiating a financial transaction, then capturing an image of at least one user engaging in a financial transaction, subsequently relaying this image to an external server where this image is paired with a log of the financial transaction. This paired image is uploaded to an external server over the internet, and is then used to verify this user's identity. This method can be performed by a system made up of a point-of-sale terminal, an image capture device, an internet-enabled electronic device capable of transferring the captured image.

### CLAIM OF PRIORITY

This application claims no priority to any previous patent or patent application.

### FIELD OF THE EMBODIMENTS

This invention relates to a system and method for a cloud-based solution for identify theft. In particular a system and method of photographically recording and storing an image of whoever initiates a given financial transaction is provided for.

### BACKGROUND OF THE EMBODIMENTS

Fraudulent use of credit cards is one of the most pervasive problems throughout modern society. Studies have shown that within the course of their life, every single American will have at least one unauthorized purchase made on one of their credit cards. Credit cards are enticing targets for fraudsters because of the very nature of credit card transactions. When a cardholder uses the card, a series of requests (data transfers) are made between the merchant, card providers, and at least one bank. The number of these transfers leaves the verification subject to many avenues of attack such that it is near impossible to have a truly robust security system for credit card authorizations. As this type of information is so frequently sought after, a number of measures have been taken to help curb this abuse, although as will be seen, each measure has various drawbacks.

Some of these measures include the addition of microchips in valid cards, the use of obscurely placed security codes, and remote verification of each transaction that occurs on a given account, among many others. However, despite these actions, incidences of credit card fraud are as high as ever. Accordingly, there exists a need for an improved means to prevent improper use of one's credit card or a similar credit-based device.

Examples of related art are described below:

U.S. Pat. No. 4,972,476 pertains to a scrambled facial image of an ID card bearer is chronicled upon a card. This image will be descrambled only when the proper descrambling control code is provided. This pixel scrambling method prevents duplication of the ID cards. This is because any reproduced card will unscramble only the image of the proper bearer, and the method inherently prevents producing a card which can be unscrambled by a verifier. New scrambling codes will be used for newly issued cards from enhanced security. Whatever clerk issues these ID's will have their initials automatically recorded upon the card. This is intended to deter unlawful card issuance. Also, unscrambled image portions are video recorded for investigation of unlawful use.

U.S. Pat. No. 6,224,109 pertains to a credit card incorporated into a driver's license. This is to provide credit to an individual while also providing information regarding the individual and proof of registration to operate a motor vehicle on a single form of identification. The credit card with driver's license is registered with a department of motor vehicles in a state in which the owner resides and credit is provided by either an independent financial institution or the state government issuing the driver's license. A strip is also positioned on a back side thereof within which the individual places a signature for purposes of authentication when accessing credit provided by said credit card with driver's license.

U.S. Pat. No. 7,039,221 pertains to a biometric facial image verification system that is capable of recognizing human users. This system includes a smart-card with pre-loaded human facial images. The system also comprises a video camera and a video digitizer embedded within said smart-card for acquiring data representative of a second human facial image. A computer-based device with a docking station capable of receiving said smart-card and software resident within said computer-based device for facial recognition, which includes Principal Component Analysis, Neural Networks, or another equivalent algorithm for comparing said first human facial images with said second human facial image and producing an output signal therefrom for use in verifying the identity of said human users. In addition, said smart-card is capable of acquiring and storing information pertaining to each of said human users such as would be required for use in a high-security environment or preventing fraud in point of sale and Internet-based financial transactions.

United States Patent Publication No.: 2011/0257985 pertains to a system and method for analyzing captured facial data with stored weights and dynamic profile in coordination with predefined rules and policy management. This system is capable of acquiring facial recognition data (“FRD”) related to a customer, processing this FRD to generate a facial data identification (“FDI”), and analyzing a database including a plurality of customer profiles to match the FDI with a stored FRD corresponding to a customer. This exemplary system and method, when the FDI is unmatched, allows for a new customer profile to be created, including the FRD and the new customer profile may be matched with a commercial application. The exemplary systems and methods may further include creation of an avatar based on the existing customer profile for communication applications, wherein the avatar is used in one of a pay-per-click application, a pay-per-action application, and a pay-per-lead application.

United States Patent Publication No.: 2014/0222596 pertains to a system and method for facilitating card-less financial transaction, wherein the face of the user can be used as the credit card for financial transaction at the point of sale (POS) or online financial transaction. The method includes capturing a user's face using a 3-D facial recognition system, converting the facial image into digital data and converting the digital data into the numeric template for that user's face. This information is then stored in a separate block within the server's database.

### SUMMARY OF THE EMBODIMENTS

The present invention provides for a computer implemented method for verifying the identity of an individual, comprising memory that stores computer-executable instructions; and a processor, communicatively coupled to the memory that facilitates execution of the computer-executable instructions method, comprising the steps of: initiating, a financial transaction; capturing, an image of at least one user engaging in said financial transaction; relaying, said image to an external server; pairing, said image with said financial transaction; uploading, said image to an external server via the internet; verifying, said user's identity. Further, the invention may be practiced at a commercial establishment, and can further comprise the step of the step of attaching, said image to all billing records related to said financial transaction.

In some embodiments, the image is captured by an in-store camera, but in other embodiments, the image may be captured by a smartphone or other internet-enabled electronic device equipped with an image capture device. In one preferred embodiment the external server of the present invention is maintained by an entity selected from the group consisting of an issuing bank, a processing entity, an acquiring bank, a financial institution, and a merchant. This can be a stand-alone server or can exist as a cloud-based platform. In a preferred embodiment, the owner of the financial instrument is notified of said financial transaction.

The present invention is intended to operate best when the financial transaction is initiated at a point-of-sale terminal. This terminal can be a cash register, self-checkout kiosk, a smartphone, a sales booth, a bank, and all other places where financial transactions occur.

The present invention also provides for a computer implemented method for verifying the identity of an individual comprising memory that stores computer-executable instructions; and a processor, communicatively coupled to the memory that facilitates execution of the computer-executable instructions method, comprising the steps of: initiating, by a user, a financial transaction; requesting, by a merchant, an authorization of said financial transaction; forwarding, said request to an acquiring bank; transmitting, said request to an issuing bank via a processing entity; verifying said request, by the issuing bank; transmitting, said verification of the request to said merchant; capturing, an image of at least one user engaging in said financial transaction; generating, a receipt of said financial transaction; relaying, said image to an external server; pairing, said image with said receipt; uploading, said image/receipt pair to an external server via the Internet; verifying, said user's identity. This method may also further comprise the step of attaching said image/receipt pair with a billing record sent to said user. This statement may include, for example, the date of the transaction, the location of the transaction, the amount of the transaction, the image of the transaction, a status identifier of the transaction, and other, not expressly mentioned information.

The present invention further provides for an identity verification system comprising; memory that stores computer-executable instructions; and a processor, communicatively coupled to the memory that facilitates execution of the computer-executable instructions; comprising: a point-of-sale terminal; an image capture device, capable of capturing an image of said point-of-sale terminal; an internet-enabled electronic device, having a communications controller, capable of connecting to the Internet; a power source; a memory; an external server; capable of storing a paired image and receipt. In some preferred embodiments, this device further comprises a local storage device, wherein said local storage device stores images captured by said image capturing device. This local storage can be used to store the original images, or can be used to store a redundant backup of the image, providing an additional layer of security. In various preferred embodiments the image capture device of this embodiment of the present invention is selected from the group consisting of security cameras, smartphone cameras, computer cameras, and web cameras.

The present invention is intended to add an additional layer of security for credit card, or other credit-based, transactions. One of the ways in which the present invention achieves this objective is by capturing, logging, and transmitting, an image of the initiator of a credit card-styled transaction at a given point-of-sale terminal. This action has a two-fold benefit: the first is that if notice is given of the recording of all persons engaging in financial transactions, a would-be fraudster will be deterred from engaging in the fraud for fear of being caught; the other benefit is that if a fraudster does indeed go through with the fraudulent transaction, the image generated will be valuable (and admissible) evidence of the perpetrator and will also provide law enforcement with a useful tool in identifying and locating this fraudster.

As such, there is a need for the present invention in the world of credit-card fraud prevention, among other industries.

It is an object of the present invention to prevent fraud.

It is an object of the present invention to assist law enforcement.

It is an object of the present invention to create logs of financial transactions.

It is an object of the present invention to assist in authenticating the identity of some engaged in a financial transaction.

### BRIEF DESCRIPTION OF THE DRAWINGS

FIG. 1 shows a flow chart of an embodiment of the method of the present invention.

FIG. 2 shows a representation of an embodiment of the system of the present invention.

FIG. 3 shows an embodiment of a billing statement generated by the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

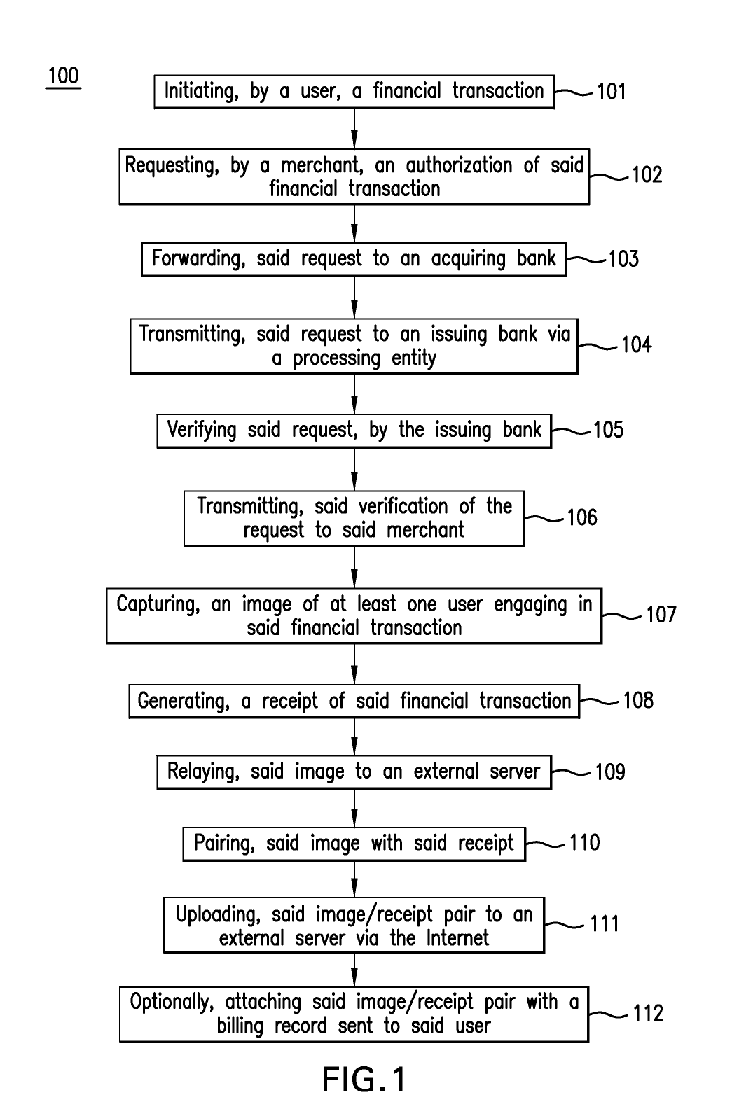

Referring to FIG. 1, a flow chart of an embodiment of the method of the present invention is provided for. Specifically, this particular embodiment of method 100 is comprised of 12 steps. Here, method 100 begins with step 101, where a user initiates a financial transaction. This can be done remotely or at a point-of-sale terminal, provided that there is an image capture device that has a line-of-sight with the user. For example, a user could be sitting at home in front of their smartphone, tablet, or computer while shopping on line or a user could be checking out at a large department store.

Once this transaction has been initiated by the user, in this particular embodiment, the standard process of validating a credit card or similarly credit-based transaction will be engaged. This is represented by steps 102-106. In sum, the merchant forwards the authorization request to their acquiring bank, which forwards it to a processing entity such as Visa® or MasterCard®, which in turn forwards the request the issuing bank, which is typically the user's bank. The issuing bank then verifies that the user has sufficient credit to complete the financial transaction and subsequently forwards the authorization (or lack thereof) back down chain to the merchant. Step 107 follows, where an image capture device will capture an image of the user engaging in the financial transaction. This image capture device may be, for example, by a security camera, a smartphone camera, a computer camera, a web camera, a digital or an analog camera. Next is step 108 where a receipt of the financial transaction is generated. In step 109, the captured image is relayed to an external server. This server can be located on the merchant's premises, can be located on an issuing or acquiring banks' premises, can be located at a user's home, or can be a cloud-based system or platform located remotely. After the image has been stored, in step 110 it becomes paired with a receipt of the financial transaction. In step 111, this paired image/receipt is sent to an external server via the internet. The external server of step 111 may be the same as the external server in 109, or may be a different external server. This will depend on how the merchant's relationship with their acquiring bank, as well as the user's relationship with their issuing bank. There also exists an optional step 112. In this optional step, the paired image/receipt will be sent to the user, bundled with their standard monthly billing record.

It should be noted that the order of the steps shown in FIG. 1 are merely illustrative of one iteration of the method of the invention. For example, the image capture device may perform step 107 immediately after or simultaneously with the initiation of the financial transaction by the user. Further, the generation of a receipt in step 108 may proceed the capturing of the image that takes place in step 107. There exist other combinations of the order of the steps shown in FIG. 1, however a person having ordinary skill in the art will contemplate the various combinations of the enumerated steps.

In alternative embodiments of the present invention, the system of the present invention is capable of capturing video at or near the location of the financial transaction. In another embodiment, the present invention is capable of logging real-time activity and displaying it on an internet-enabled electronic device. In yet another embodiment, the present invention is capable of interfacing with payment processing providers and non-standard issuers of credit, such as, but not limited to Facebook, Apple, Google, PayPay. In a preferred embodiment, the present invention incorporates a third-party facial recognition API.

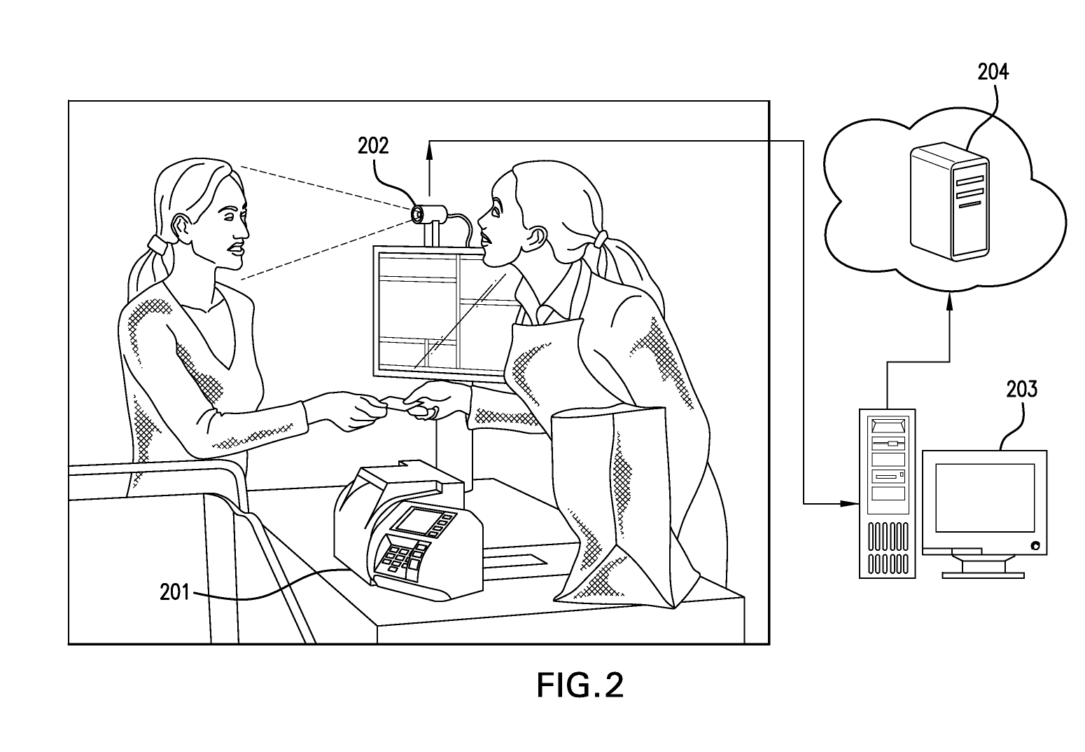

Referring to FIG. 2, a representation of an embodiment of the system of the present invention is shown. Here, point-of-sale terminal 201, image capture device 202, internet-enabled electronic device 203, and external server 204. It should be noted that while here, point-of-sale terminal 201 and image capture device 202 are discrete elements, they could be integrated into a single system. In a preferred embodiment, the point-of-sale terminal 201/image capture device 202, and internet-enabled electronic device 203 are integrated into a single device.

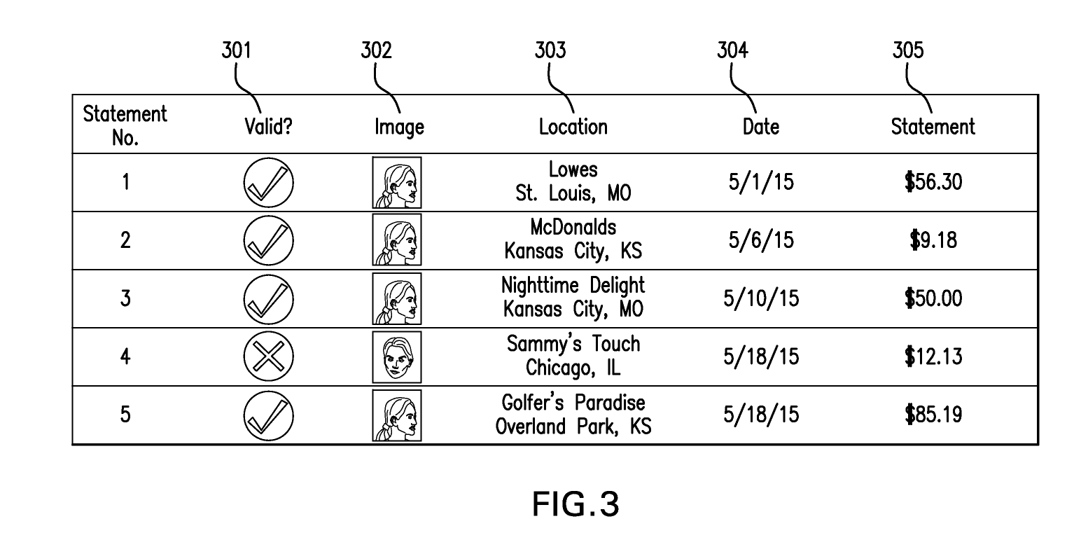

FIG. 3 shows an embodiment of a billing statement generated by the present invention. In this particular embodiment, the billing statement has a validity indication 301, an image of the person engaging in a transaction 302, the location of transaction 303, date of transaction 304, and amount of transaction 305. In a preferred embodiment, image 302 is verified against a preexisting database of images. In another embodiment, image 302 is verified against a user-provided image. In yet another embodiment, image 302 is verified against the images obtained from all other transactions by that user.

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the present invention may be connected to and/or communicate with entities such as, but not limited to: one or more users from user input devices; peripheral devices; an optional cryptographic processor device; and/or a communications network. For example, the present invention may be connected to and/or communicate with users, operating client device(s), including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory.

Computer Systemization

A computer systemization may comprise a clock, central processing unit (“CPU(s)” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O. In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing the controller of the present invention to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present invention may be implemented via the microprocessor and/or via embedded components; e.g., via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the features of the present invention. A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present invention.

Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present invention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed embodiments of the present invention), architectures may similarly be employed to pool, load balance, and/or otherwise increase the communicative bandwidth required by the controller of the present invention. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices, such as other components of the cooling chest system, including temperature sensors, ice dispensers (if provided) and the like may be connected and/or communicate to I/O and/or other facilities of the like such as network interfaces, storage interfaces, directly to the interface bus, system bus, the CPU, and/or the like. Peripheral devices may be external, internal and/or part of the controller of the present invention. Peripheral devices may also include, for example, an antenna, audio devices (e.g., line-in, line-out, microphone input, speakers, etc.), cameras (e.g., still, video, webcam, etc.), drive motors, ice maker, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

Operating System

The operating system component is an executable program component facilitating the operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. The operating system may be one specifically optimized to be run on a mobile computing device, such as iOS, Android, Windows Phone, Tizen, Symbian, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the controller of the present invention based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present invention. The combined application may be nugatory on systems employing standard Web browsers.

Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invention.

Access to the mail of the present invention may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Database of the Present Invention

The database component of the present invention may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component includes several tables. A Users (e.g., operators and physicians) table may include fields such as, but not limited to: user_id, ssn, dob, first_name, last_name, age, state, address_firstline, address_secondline, zipcode, devices_list, contact_info, contact_type, alt_contact_info, alt_contact_type, and/or the like to refer to any type of enterable data or selections discussed herein. The Users table may support and/or track multiple entity accounts. A Clients table may include fields such as, but not limited to: user_id, client_id, client_ip, client_type, client_model, operating_system, os_version, app_installed_flag, and/or the like. An Apps table may include fields such as, but not limited to: app_ID, app_name, app_type, OS_compatibilities_list, version, timestamp, developer_ID, and/or the like. A beverages table including, for example, heat capacities and other useful parameters of different beverages, such as depending on size beverage_name, beverage_size, desired_coolingtemp, cooling_time, favorite_drinker, number_of beverages, current_beverage_temperature, current_ambient_temperature, and/or the like. An Parameter table may include fields including the foregoing fields, or additional ones such as cool_start_time, cool_preset, cooling_rate, and/or the like. A Cool Routines table may include a plurality of cooling sequences may include fields such as, but not limited to: sequence_type, sequence_id, flow_rate, avg_water_temp, cooling_time, pump_setting, pump_speed, pump_pressure, power_level, temperature_sensor_id_number, temperature_sensor_location, and/or the like.

In one embodiment, user programs may contain various user interface primitives, which may serve to update the platform of the present invention. Also, various accounts may require custom database tables depending upon the environments and the types of clients the system of the present invention may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components. The system of the present invention may be configured to keep track of various settings, inputs, and parameters via database controllers.

Various other components may be included and called upon for providing for aspects of the teachings herein. For example, additional materials, combinations of materials and/or omission of materials may be used to provide for added embodiments that are within the scope of the teachings herein. In the present application a variety of variables are described, including but not limited to components and conditions. It is to be understood that any combination of any of these variables can define an embodiment of the disclosure. Other combinations of articles, components, conditions, and/or methods can also be specifically selected from among variables listed herein to define other embodiments, as would be apparent to those of ordinary skill in the art.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

What is claimed is:

1. A computer implemented method for verifying the identity of an individual, comprising memory that stores computer-executable instructions; and a processor, communicatively coupled to the memory that facilitates execution of the computer-executable instructions method, comprising the steps of:
initiating, a financial transaction;
capturing, an image of at least one user engaging in said financial transaction;
relaying, said image to an external server;
pairing, said image with said financial transaction;
uploading, said image to an external server via the internet;
verifying, said user's identity.

2. The method of claim 1, wherein said financial transaction is initiated at a commercial establishment.

3. The method of claim 1, further comprising the step of attaching, said image to all billing records related to said financial transaction.

4. The method of claim 1, wherein said image is captured by an in-store camera.

5. The method of claim 1, wherein said image is captured by a smartphone.

6. The method of claim 1, wherein said external server is maintained by an entity selected from the group consisting of an issuing bank, a processing entity, an acquiring bank, and a merchant.

7. The method of claim 6, further comprising the step of notifying the owner of the financial instrument of said financial transaction.

8. The method of claim 1, wherein said financial transaction is initiated at a point-of-sale terminal.

9. The method of claim 1, wherein said external server is maintained by a financial institution.

10. The method of claim, wherein said external server is a cloud-based system.

11. A computer implemented method for verifying the identity of an individual comprising memory that stores computer-executable instructions; and a processor, communicatively coupled to the memory that facilitates execution of the computer-executable instructions method, comprising the steps of:
initiating, by a user, a financial transaction;
requesting, by a merchant, an authorization of said financial transaction;
forwarding, said request to an acquiring bank;
transmitting, said request to an issuing bank via a processing entity;
verifying said request, by the issuing bank;
transmitting, said verification of the request to said merchant;
capturing, an image of at least one user engaging in said financial transaction;
generating, a receipt of said financial transaction;
relaying, said image to an external server;
pairing, said image with said receipt;
uploading, said image/receipt pair to an external server via the Internet;
verifying, said user's identity.

12. The method of claim 11, further comprising the step of:
attaching said image/receipt pair with a billing record sent to said user.

13. A identity verification system comprising;
memory that stores computer-executable instructions; and a processor, communicatively coupled to the memory that facilitates execution of the computer-executable instructions; comprising;
a point-of-sale terminal;
an image capture device, capable of capturing an image of said point-of-sale terminal;
an internet-enabled electronic device, having
a communications controller, capable of connecting to the Internet;
a power source;
a memory;
an external server; capable of storing a paired image and receipt.

14. The system of claim 13, further comprising a local storage device, wherein said local storage device stores images captured by said image capturing device.

15. The system of claim 13, wherein said external server is a cloud-based platform.

16. The system of claim 13, wherein said image capture device is selected from the group consisting of security cameras, smartphone cameras, computer cameras, and web cameras.
